(19) United States
(12) Patent Application Publication
(10) Pub. No.: US 2005/0039584 A1
(43) Pub. Date: Feb. 24, 2005

(54) Rotating shearing device and method for separating the front crop and rear crop from running rolling stock

(75) Inventor: Rainer Hellenbrandt, Willich (DE)

Correspondence Address: COHEN, PONTANI, LIEBERMAN & PAVANE, Suite 1210, 551 Fifth Avenue, New York, NY, 10176, US

(73) Assignee: SMS Demag AG

(21) Appl. No.: 10/915,793

(22) Filed: Aug. 11, 2004

Related U.S. Application Data
(63) Continuation-in-part of application No. 09/991,856, filed on Nov. 14, 2001.

(30) Foreign Application Priority Data
Nov. 15, 2000 (DE) 100 57 717.2

(51) Int. Cl. B26D 1/00

(52) U.S. Cl. 83/13; 83/102; 83/106

(57) ABSTRACT

A rotating shearing device for cropping fast-running rolling stock, in particular wire, with two axially cutting annular knives which rotate about their axis at the same rotational speed with end cutting edges directed toward one another. The cutting edges converge to the clearance necessary for separating the rolling stock during a cutting operation and lie in planes which are arranged at an acute angle to one another. Rolling stock is guided to the shearing device by a front guide and from the shearing device by a rear guide. The running stock may be guided either through the space between the annular knives which is free for the cut-free passage of the rolling stock or into the wedge-shaped cutting region of the annular knives which is defined by the gripping angle. The front guide is pivotable, the rear guide is fixed and the shearing device is raisable and lowerable in relation to the rear guide.

### CROSS REFERENCE TO RELATED APPLICATION

The present invention is a Continuation-In-Part of U.S. patent application Ser. No. 09/991,856, filed on Nov. 14, 2001, which claims priority from German Patent Document DE 100 57 717, filed on Nov. 15, 2000.

### BACKGROUND OF THE INVENTION

1. Field of the Invention

The invention relates to a rotating shearing device for cropping fast-running rolling stock and a method for separating the front crop and the rear crop from the running rolling stock by a shearing device.

2. Description of the Related Art

A rotating shearing device of the generic type is disclosed in U.S. Pat. No. 3,491,640.

A further shearing device of this type is shown in DE-A 24 35 486, which also shows the conventional overall plant which consists of two shearing devices arranged one behind the other. The front crop is separated from the rolling stock by the front or first shearing device. After the rolling stock is run through, the rear crop is then separated by the second shearing device. Each of the guides arranged in front of the shearing devices is mounted pivotably, that is to say the end of the guide facing the shearing device is capable of being raised and lowered in relation to the respective fixedly arranged shearing device. The rolling stock can therefore be brought into the cutting range of the annular knives, for this purpose the guide arranged in front of the shearing device being pivoted upward.

Fixedly positioned guides are provided behind the shearing devices for receiving the front crop and rear crop, respectively.

The necessary use of two shearing devices, with all the associated guides, drives and controls, gives rise to very high plant costs which then, of course, also entail high operating and maintenance costs. Furthermore, these plants require a large amount of space.

### SUMMARY OF THE INVENTION

The object of the present invention is to provide a shearing device and method for separating the front crop and rear crop with reduced costs and reduced space requirements.

The object of the present invention is achieved by a rotating shearing device for cropping fast-running rolling stock, in particular wire, with two axially cutting annular knives which rotate about their axis at the same rotational speed with end cutting edges directed toward one another. The cutting edges converge to the clearance necessary for separating the rolling stock during a cutting operation and lie in planes which are arranged at an acute angle to one another. Rolling stock is guided to the shearing device by a front guide and from the shearing device by a rear guide. The running stock may be guided either through the space between the annular knives which is free for the cut-free passage of the rolling stock or into the wedge-shaped cutting region of the annular knives which is defined by the gripping angle. The front guide is pivotable, the rear guide is fixed and the shearing device is raisable and lowerable in relation to the rear guide.

According to the invention, only one shearing device is used which separates both the front crop and the rear crop. Which part is separated and correspondingly conveyed away is determined the interaction of the guide part arranged in front of the shearing device and behind the shearing device with the shearing device or the respective position of the annular knives in relation to one another.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a schematic view of a shearing device according to the present invention with a front guide that is in a lower position and annular knives that are in a basic position;

FIG. 1a is a front view of the shearing device of FIG. 1 along a direction of movement of the moving stock;

FIG. 2 is a schematic view of the shearing device of FIG. 1 with the front guide in a middle position and the annular knives in the basic position;

FIG. 2a is a front view of the shearing device of FIG. 2 along a direction of movement of the moving stock;

FIG. 3 is a schematic view of the shearing device of FIG. 1 with the front guide in the middle position and the annular knives in a high position;

FIG. 3a is a front view of the shearing device of FIG. 3 along a direction of movement of the moving stock;

FIG. 4 is a schematic view of the shearing device of FIG. 1 with the front guide in an upper position and the annular knives in the high position;

FIG. 4a is a front view of the shearing device of FIG. 4 along a direction of movement of the moving stock; and

FIG. 5 is a partial sectional view of the shearing device of FIG. 1 along the path of the running stock.

### DETAILED DESCRIPTION OF THE PRESENTLY PREFERRED EMBODIMENTS

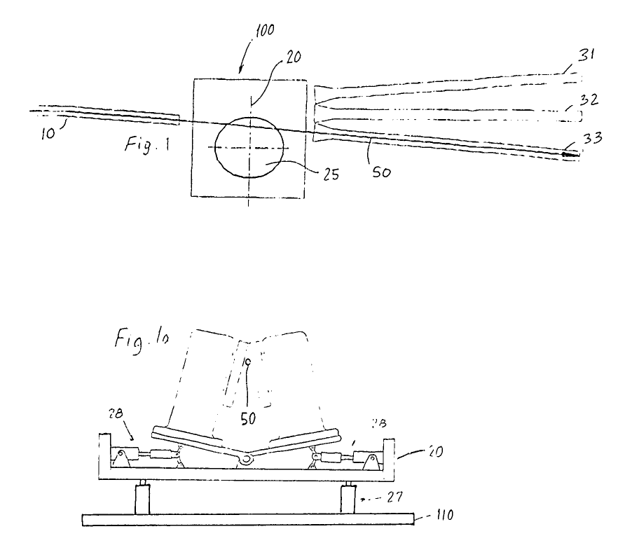

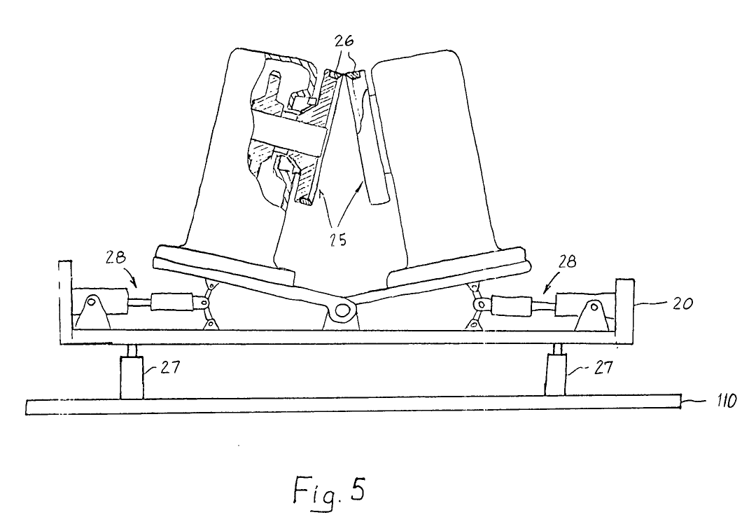

FIG. 1 shows a chop-shearing device 100 at the start of the run-through of the rolling-stock 50 in the free space between the annular knives 25 mounted in a shearing device frame 20. The frame 20 is mounted on a base 110 and is moveable from a basic position to a raised position as described below. The arrangement of the annular knives is as disclosed in U.S. Pat. No. 3,491,640 (Poran), the entire contents of which is incorporated herein by reference. The annular knives are laterally movable toward each other to a cutting position and away from each other by a mechanism 28 (FIG. 5 shows the cutting position). Examples of such mechanisms 28 are disclosed by the above-mentioned U.S. Pat. No. 3,491,640.

In the initial position of the chop-shearing device 100 shown in FIG. 1, a front guide part 10 is in its lower position and the shearing device frame 20 in its basic position. The tip of the rolling-stock 50 runs obliquely downward into the lower of the rear three rear guides 31, 32, 33 and thus arrives at the chop-shearing device. As shown in FIG. 1a, the rolling stock 50 runs below the point where the two annular knives meet in the initial position of the chop shearing device 100.

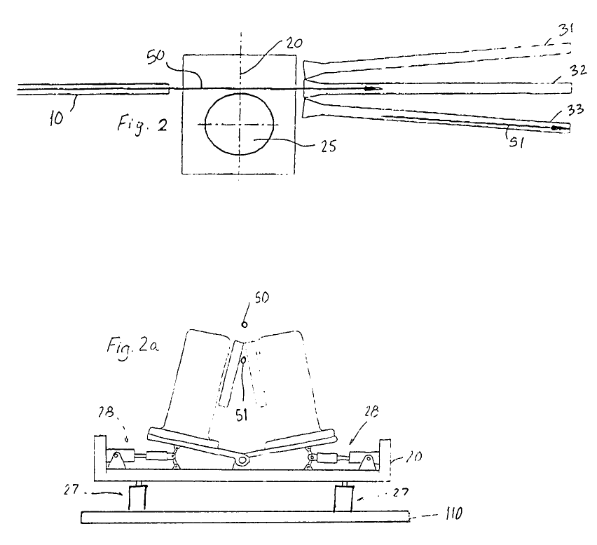

For separating the front crop 51 of the rolling stock 50, the front guide part 10 is pivoted upward as far as a middle position as shown in FIG. 2. Since the annular knives 25 are in this case in their cutting position, separation of the running stock 50 occurs. The cut-off portion, i.e., the front crop 51, continues to run further on through the lower guide 33 of the three rear guides 31, 32, 33. The rolling stock 50, now free of the front crop 51, is guided by the front guide part 10 which is in the middle position through the middle guide 32 of the three rear guides 31, 32, 33 to a winder. The positions of the rolling stock 50 and the front crop 51 relative to the annular knives 25 after the front crop 51 is separated are shown in FIG. 2a.

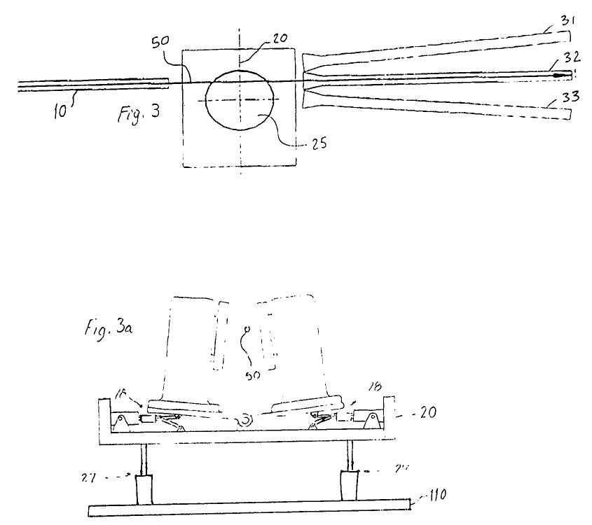

During the further run-through of the rolling stock 50, the annular knives 25 are moved to a separated or opened position (see FIG. 3a) and the shearing device frame 20 is moved from the basic position into a high position relative to the base 110 of the crop shearing device 100 as shown in FIG. 3 without cutting the rolling stock 50. A raise-lower mechanism 27 is used to move the shearing device frame 20 from the basic position to the high position. Subsequently, the annular knives 25 are brought back to the cutting position such that the rolling stock again runs below the point the two annular knives meet. The raise lower mechanism 27 may comprise any actuator for effecting the desired movement such as, for example, a hydraulic or pneumatic piston-cylinder unit or a solenoid.

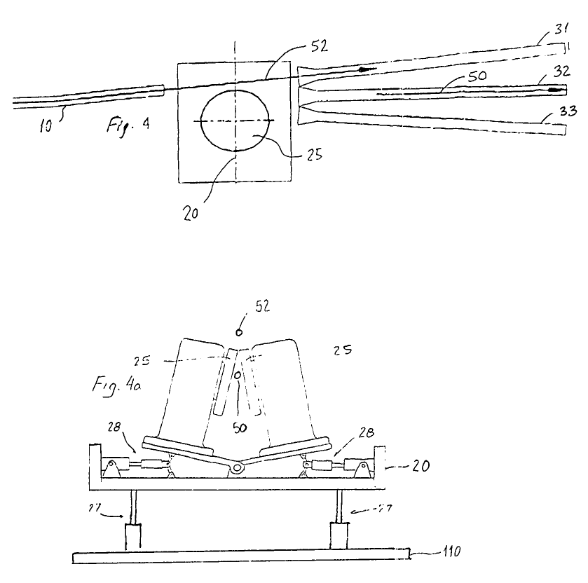

To separate a rear crop 52, the front guide part 10 pivots from the middle position into the upper position as shown in FIG. 4. The rear crop 52 is separated from the rolling stock 50 and is led through the upper guide 31 of the rear guide parts 31, 32, 33 of the chop-shearing device 100. FIG. 4a shows the positions of the rolling stock 50 and the rear crop 52 relative to the annular knives after the rear crop has been separated from the rolling stock 50.

After the rear crop is removed from the crop shearing device 100, the front guide part 10 may be pivoted downward and the shearing device 20 moved down into the basic position soo that the chop shearing device 100 is again in the initial position as shown in FIG. 1.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

For example, the mechanisms 27 for raising and lowering the shearing device frame 20 and the mechanism 28 for moving the annular knives 25 to and from the cutting position may comprise any known devices for accomplishing the described movement. The mechanisms 27 and 28 may be controlled by separate actuators or mechanically interconnected to a single actuator. The actual mechanism is not important. Rather, the movement which allows both the front crop and the rear crop to be separated by the same shearing device.

1. A rotating shearing device for cropping fast-running rolling stock, comprising:
a shearing device frame;
two axially cutting annular knives mounted in said shearing device frame for rotation about respective axes at the same rotational speed, each of said two annular knives having end cutting edges directed toward one another, said cutting edges converging to a cutting position with a clearance necessary to separate the rolling stock during a cutting operation, said two annular knives arranged at an acute angle to one another and intersect one another along a line;
a front guide arranged for guiding the rolling stock to said shearing device frame, said front guide being switchable between an upper end position and a lower end position; and
a rear guide arranged for guiding a first crop of the running stock, the running stock, and a rear crop of the running stock from said shearing device frame, said rear guide having three fixed rear guide parts,
wherein said shearing device frame is movable relative to said rear guide between a lower basic position and a high position, said annular knives being movable to said cutting position in both said lower basic position and said high position of said shearing device frame such that said to annular knives are operable to perform the cutting operation in both said lower basic position and said high position.

2. A method for separating a front crop and a rear crop from a running rolling stock using a rotating shearing device, wherein the rotating shearing device has a shearing device frame, two axially cutting annular knives mounted in said shearing device frame, a front guide arranged for guiding the rolling stock to said shearing device frame, the front guide being switchable between an upper end position and a lower end position, and a rear guide arranged for guiding the rolling stock from said shearing device frame, the rear guide having three fixed rear guide parts, wherein the shearing device frame is movable relative to the rear guide between a lower basic position and a high position, the method comprising the steps of:
introducing a start of the running rolling stock into a free space between the annular knives and into the lower one of the three fixed rear guide parts by the front guide part in an initial state of the rotating shearing device in which the front guide part is in a lower end position, the shearing device frame is in the lower basic position and the annular knives are in the cutting position;
pivoting the front guide part up to a middle position for separating the front crop with the annular knives and discharging the front crop into the lower guide part of the three rear guide parts;
running the rolling stock through the shearing device above the annular knives into the middle guide part of the three rear guide parts after the front guide part is pivoted to the middle position;
opening the annular knives and moving the shearing device frame into the high position such that the running rolling stock discharged from the front guide part in the middle position is in the free space between the annular knives;
closing the annular knives into the cutting position and subsequently pivoting the front guide part upward from the middle position for separating the rear crop with the annular knives and discharging the rear crop through an upper guide part of the three rear guide parts; and
pivoting the front guide part to the lower end position and moving the shearing device frame back to the lower basic position for establishing the initial state.
